(19) United States
(12) Patent Application Publication
(10) Pub. No.: US 2017/0338457 A1
(43) Pub. Date: Nov. 23, 2017

(54) COMPOSITE BARIUM SULFATE DIAPHRAGM AND PREPARATION METHOD THEREFOR, AND LITHIUM-ION BATTERY

(71) Applicants: Jiangsu Huadong Institute of Li-Ion Battery Co., Ltd., Suzhou (CN); Tsinghua University, Beijing (CN)

(72) Inventors: YU-MING SHANG, Beijing (CN); XIAO-LEI DING, Beijing (CN); XIANG-MING HE, Beijing (CN); LI WANG, Beijing (CN); JIAN-JUN LI, Beijing (CN); ZHEN LIU, Beijing (CN); ZHI-XIN XU, Beijing (CN); YAO-WU WANG, Beijing (CN); JIAN GAO, Beijing (CN)

(73) Assignees: Jiangsu Huadong Institute of Li-Ion Battery Co., Ltd., Suzhou (CN); Tsinghua University, Beijing (CN)

(21) Appl. No.: 15/674,531

(22) Filed: Aug. 11, 2017

Related U.S. Application Data
(63) Continuation of application No. PCT/CN2015/077798, filed on Apr. 29, 2015.

(30) Foreign Application Priority Data
Feb. 12, 2015 (CN) 201510073292.6

(51) Int. Cl. H01M 2/16; H01M 2/14; H01M 10/0525

(52) U.S. Cl. CPC H01M 2/1646; H01M 10/0525; H01M 2/145; H01M 2/1653; H01M 2/1686

(57) ABSTRACT

A composite barium sulfate diaphragm is disclosed. The composite barium sulfate diaphragm includes a base membrane, and a coating layer coated on the base membrane. The coating layer includes nano-barium sulfate. A surface of the nano-barium sulfate is modified with the lithium carboxylate group. A method for preparing the composite barium sulfate diaphragm and a lithium-ion battery are also provided.

### CROSS-REFERENCE TO RELATED APPLICATIONS

This application claims all benefits accruing under 35 U.S.C. §119 from China Patent Application No. 201510073292.6, filed on Feb. 12, 2015 in the State Intellectual Property Office of China, the content of which is hereby incorporated by reference. This application is a continuation under 35 U.S.C. §120 of international patent application PCT/CN2015/077798 filed on Apr. 29, 2015, the content of which is also hereby incorporated by reference.

### FIELD

The present disclosure relates to composite barium sulfate diaphragm and preparation method therefor, and lithium-ion battery.

### BACKGROUND

A lithium-ion battery includes a cathode, an anode, diaphragm and electrolyte. Although the diaphragm is not involved in the electrochemical reaction in the lithium-ion battery, it is still an important component of the lithium-ion battery. The diaphragm of the prior art is generally a microporous polyolefin membrane. When the temperature increases, the microporous polyolefin membrane will shrink, which could cause a short circuit in the lithium-ion battery. Because the microporous polyolefin membrane has a hydrophobic surface, the microporous polyolefin membrane has poor wettability, which increases the internal resistance of the lithium-ion battery. Therefore, cycle performance, charge and discharge performance of the lithium-ion battery are negatively affected by a microporous polyolefin membrane diaphragm. Thus, the diaphragm of the lithium-ion battery plays an important role in the performance of the lithium-ion battery.

In recent years, to improve the performance of the diaphragm of the lithium-ion battery, nano-barium sulfate is coated on the diaphragm surface to enhance thermal stability of the diaphragm. However, commercialized nano-barium sulfate agglomerates easily. Despite complex and time-consuming grinding and dispersing, the commercialized nano-barium sulfate is still difficult to disperse uniformly to coat on the diaphragm. The diaphragm of the lithium-ion battery with the applied nano-barium sulfate has difficulty preventing thermal shrinkage.

### SUMMARY

The composite barium sulfate diaphragm includes a base membrane and a coating layer coated on the base membrane. The coating layer includes nano-barium sulfate and a binder. Surface of the nano-barium sulfate is modified with lithium carboxylate group.

A method for preparing the composite barium sulfate diaphragm is also provided. The method comprises:
mixing a lithium carboxylate solution and a soluble barium salt aqueous solution to form a first solution;
providing a soluble sulfate aqueous solution with a pH of 8 to 10, and adding the soluble sulfate aqueous solution to the first solution to react to obtain a precipitate;
separating, water washing and drying the precipitate to obtain a nano-barium sulfate modified with lithium carboxylate group;
mixing the nano-barium sulfate modified with lithium carboxylate group and a binder to obtain a mixed slurry; and
coating the mixed slurry on a base membrane.

A lithium-ion battery includes a cathode, an anode, the composite barium sulfate diaphragm disposed between the cathode and the anode, and a non-aqueous electrolyte permeated in the composite barium sulfate diaphragm.

The composite barium sulfate diaphragm provided in this disclosure includes nano-barium sulfate modified with lithium carboxylic group. The nano-barium sulfate modified with lithium carboxylic group is easy to disperse uniformly. In the coating layer of the composite barium sulfate diaphragm, the nano-barium sulfate modified with lithium carboxylic group is uniformly dispersed. Therefore, the composite barium sulfate diaphragm can prevent thermal shrinkage. The nano-barium sulfate modified with lithium carboxylic group can facilitate the transmission of lithium ions to improve the electrochemical properties of the lithium-ion battery.

### BRIEF DESCRIPTION OF THE DRAWINGS

FIG. 1 is a Scanning Electron Microscope (SEM) image of nano-barium sulfate of one embodiment.

FIG. 2 is a SEM image of a composite barium sulfate of one embodiment.

FIG. 3 shows changes of thermal shrinkage at different temperatures of the composite barium sulfate of Example 1.

FIG. 4 shows cycle performance curves of lithium-ion batteries of Example 1 and Comparative Example 2.

### DETAILED DESCRIPTION

A detailed description with the above drawings is made to further illustrate the present disclosure.

One embodiment of a method for preparing a composite barium sulfate diaphragm includes:

S1, mixing a lithium carboxylate solution and a soluble barium salt aqueous solution to form a first solution;

S2, providing a soluble sulfate aqueous solution with a pH of 8 to 10, adding the soluble sulfate aqueous solution to the first solution to react to obtain a precipitate;

S3, separating, water washing and drying the precipitate to obtain a nano-barium sulfate modified with lithium carboxylate group; and

S4, mixing the nano-barium sulfate modified with lithium carboxylate group and a binder to obtain a mixed slurry, and coating the mixed slurry on a base membrane.

In step S1, the lithium carboxylate solution can be obtained by dissolving a lithium carboxylate in an organic solvent. The lithium carboxylate and Ba²⁺ of the soluble barium salt can form a stable complex of barium-lithium carboxylate in the first solution. The complex of barium-lithium carboxylate can slowly release Ba²⁺ in a subsequent process. Therefore, particles of barium sulfate do not grow too large, thereby forming nano-barium sulfate modified with a lithium carboxylate group. Further, during the process of precipitating, the nano-barium sulfate modified with lithium carboxylate group does not agglomerate easily. The lithium carboxylate group can increase a carrier ion concentration on a surface of the nano-barium sulfate, which can promote lithium ion transport in the composite barium sulfate diaphragm obtained by the method.

The lithium carboxylate includes at least eight carbon atoms. The lithium carboxylate can be selected from the group consisting of lithium oleate, lithium stearate, lithium benzoate dodecyl, hexadecyl lithium benzoate and lithium polyacrylate thereof. A mass of the lithium carboxylate can be 1% to 5% by mass of a theoretical mass of the nano-barium sulfate modified with the lithium carboxylate group subsequently formed.

The organic solvent can dissolve the lithium carboxylate, and cause the nano-barium sulfate to form a mesoporous material inside in a subsequent process. The organic solvent can be a water-soluble polar organic solvent. The organic solvent can be methanol, ethanol, isopropanol, acetone, N, N-dimethylformamide, N, N-dimethylacetamide or N-methylpyrrolidone. In one embodiment, the organic solvent can be an alcohol solvent, such as ethanol, methanol or isopropanol. A volume ratio of the organic solvent and the soluble barium salt aqueous solution can be in a range from about 1:1 to about 2:1. In one embodiment, the volume ratio of the organic solvent and the soluble barium salt aqueous solution is about 1:1.

A concentration of the soluble barium salt aqueous solution can be in a range from about 0.1 mol/L to about 0.5 mol/L. The soluble barium salt can be barium chloride, barium nitrate, barium sulfide, or other soluble barium salt.

In step S2, the soluble sulfate aqueous solution is slowly added to the first solution. The complex of barium-lithium carboxylate in the first solution can slowly release Ba²⁺. The Ba²⁺ and SO₄²⁻ of the soluble sulfate aqueous solution can form particles of the nano-barium sulfate in nanometer size. The nano-barium sulfate is not soluble and can be obtained as the precipitate. The surface of the nano-barium sulfate is modified with a lithium carboxylate group. The nano-barium sulfate is the mesoporous material. The soluble sulfate can be sodium sulfate, potassium sulfate, ammonium sulfate or aluminum sulfate. A concentration of the soluble sulfate aqueous solution can be in a range from about 0.1 mol/L to about 0.5 mol/L. A molar ratio of the soluble sulfate and the soluble barium salt can be 1:1. A pH of the soluble sulfate aqueous solution can be adjusted in a range from about 8 to about 10 by ammonia,

In step S3, the precipitate can be separated from the solution by centrifugation. The precipitate separated from the solution can be washed with water 3 or 4 times. The precipitate washed with water can be dried in vacuum to obtain the nano-barium sulfate modified with lithium carboxylate group. A particle size of the nano-barium sulfate modified with lithium carboxylate group can be in a range from about 30 nm to about 500 nm. A specific surface area of the nano-barium sulfate modified with the lithium carboxylate group can be in a range from about 5 m²/g to about 20 m²/g. Each particle of the nano-barium sulfate modified with lithium carboxylate group is a mesoporous material. A pore size of the mesoporous material can be in a range from about 6 nm to about 10 nm.

From step S1 to step S3, a temperature in the processes can be in a range from about 15° C. to about 45° C.

In step S4, the binder can be polyacrylonitrile, polyvinyl acetate, polyvinyl pyrrolidone, polyvinylidene fluoride or polyimide. The binder can be used to make the nano-barium sulfate modified with lithium carboxylate group better combine with the base membrane.

The base membrane can be a porous polyolefin membrane. The porous polyolefin membrane can be a porous polyolefin polypropylene film, a porous polyethylene film, a porous polypropylene film, a porous polypropylene-polyethylene-polypropylene composite film or a porous nonwoven fabric film. The base membrane is used to isolate electrons and let lithium ions pass through pores of the base membrane. The base membrane can be a commercially available lithium-ion battery separator, such as Asahi, Tonen, Ube, or products of Celgard. In one embodiment, the base membrane is a Celgard-2325 film.

The step S4 further includes steps of:

S41, mixing and agitating the nano-barium sulfate modified with the lithium carboxylate group and a polar solvent to uniformly disperse the nano-barium sulfate in the polar solvent to obtain a mixed solution;

S42, adding the binder to the mixed solution, agitating the mixed solution to resolve the binder in the mixed solution to form the mixed slurry; and

S43, coating the mixed slurry on a surface of the base membrane to form a coating layer, and drying the base membrane to obtain the composite barium sulfate diaphragm.

In step S41, the surface of the nano-barium sulfate is modified with the lithium carboxylic group. The lithium carboxylic group acts as a surfactant and helps the nano-barium sulfate modified with lithium carboxylic group to disperse uniformly in the polar solvent. The polar solvent can be selected from the group consisting of N, N-dimethylformamide, N, N-dimethyl acetamide, and N-methylpyrrolidone thereof.

A mass ratio of the binder and the nano-barium sulfate can be in a range from about 5:100 to about 15:100 in the mixed slurry. A mass ratio of a sum of the binder and barium sulfate and the polar solvent can be in a range from about 5:100 to about 20:100.

It is to be understood that the coating layer can be located on either or both sides of the base membrane. The base membrane coated with the coating layer is dried at a temperature of 60° C. to 80° C. in vacuum for 12 hours to 24 hours to remove the remaining solvent in the coating layer. A thickness of the coating layer after drying can be in a range from about 2 μm to about 10 μm.

A composite barium sulfate diaphragm of one embodiment is also provided. The composite barium sulfate diaphragm includes the base membrane and the coating layer coated on the base membrane. The coating layer includes nano-barium sulfate and binder. The nano-barium sulfate is uniformly dispersed in the coating layer and can prevent thermal shrinkage of the base membrane. Surface of the nano-barium sulfate is modified with a lithium carboxylate group. The nano-barium sulfate modified with the lithium carboxylate group does not agglomerate easily and is easy to disperse. The nano-barium sulfate modified with the lithium carboxylate group is uniformly coated on the surface of the base membrane during preparing the composite barium sulfate diaphragm. The lithium carboxylate group facilitates lithium ions transport in the composite barium sulfate diaphragm. The particles of the nano-barium sulfate modified with lithium carboxylate group is a mesoporous material, and a certain gap forms between the particles of the nano-barium sulfate modified with the lithium carboxylate group. Therefore, the composite barium sulfate diaphragm has high porosity which is beneficial to increase permeability of the electrolyte. The wettability of the composite barium sulfate diaphragm permeable is also further improved.

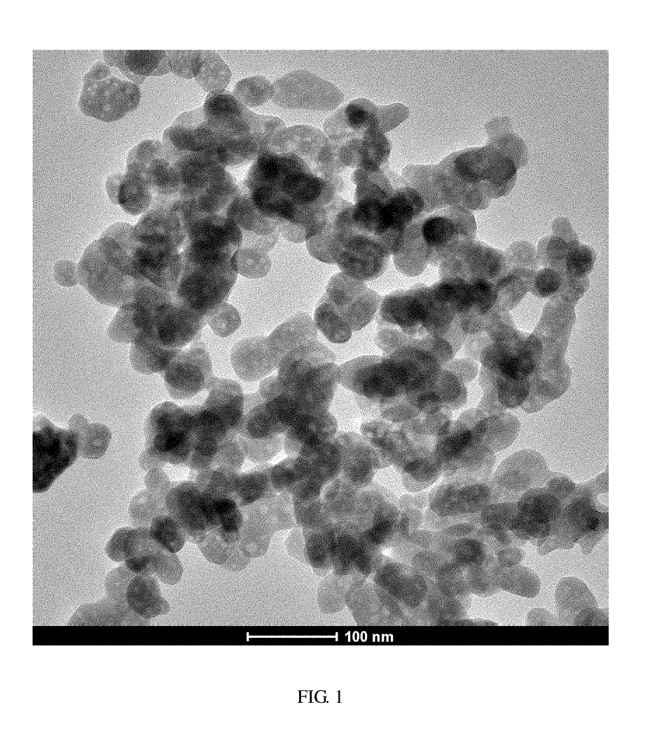

Referring to FIG. 1, a particle size of the nano-barium sulfate modified with the lithium carboxylate group is about 30 nm to 500 nm. A gap in nanometer is formed between the particles of the nano-barium sulfate modified with the lithium carboxylate group. Each particle of the nano-barium sulfate modified with the lithium carboxylate group is a mesoporous material. A pore size of the mesoporous material can be in a range from about 6 nm to about 10 nm.

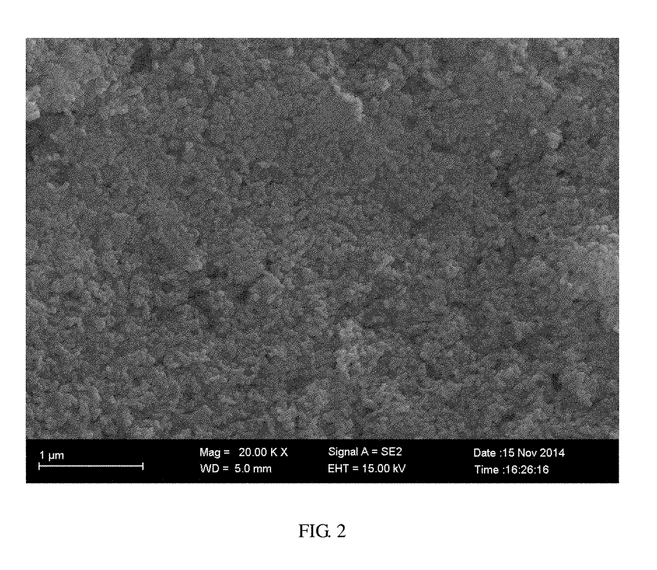

Referring to FIG. 2, the composite barium sulfate diaphragm is shown. The coating layer is uniformly covered on the surface of the base membrane. The nano-barium sulfate modified with the lithium carboxylate group is uniformly dispersed in the coating layer. A thickness of the coating layer is in a range from about 2 μm to about 10 μm.

A lithium-ion battery of one embodiment is also provided. The lithium-ion battery includes a cathode, an anode, the composite barium sulfate diaphragm disposed between the cathode and anode, and a non-aqueous electrolyte permeated in the composite barium sulfate diaphragm.

The non-aqueous electrolyte comprises a solvent and a lithium salt dissolved in the solvent. The solvent can be selected from a first group consisting of cyclic carbonates, chain carbonates, cyclic ethers, chain ethers, nitriles and amides thereof. The solvent can be selected from a second group consisting of ethylene carbonate, propylene carbonate, diethyl carbonate, dimethyl carbonate, methyl ethyl carbonate, methyl acetate, ethyl acetate, propyl acetate, methyl propionate, ethyl propionate, diethyl ether, acetonitrile, propionitrile, anisole, butyrate, glutaronitrile, adiponitrile, γ-butyrolactone, γ-valerolactone, tetrahydrofuran, 1,2-dimethoxyethane and acetonitrile thereof. The lithium salt can be selected from the group consisting of dimethylformamide (LiCF4), lithium hexafluoride (LiAsF6), lithium perchlorate (LiClO4), and lithium bis-oxalic acid lithium borate (LiBOB) thereof.

The cathode can include a cathode current collector and a cathode material layer. The cathode current collector is used to support the cathode material layer and is conductive. A shape of the cathode current collector can be foil or mesh. A material of the cathode current collector can be selected from the group consisting of aluminum, titanium and stainless steel thereof. The cathode material layer is disposed on at least one surface of the cathode current collector. The cathode material layer includes a cathode active material. The cathode material layer optionally further includes a conductive agent and a cathode binder. The conductive agent and the cathode binder can be uniformly mixed with the cathode active material. The cathode active material can be selected from the group consisting of lithium iron phosphate, lithium manganese oxide spinel, lithium cobalt oxide, lithium nickel oxide and nickel-cobalt-manganese ternary materials thereof.

The anode can include an anode current collector and an anode material layer. The anode current collector is conductive and used to support the anode material layer. A shape of the anode current collector can be foil or mesh. A material of the anode current collector can be selected from the group consisting of copper, nickel, and stainless steel thereof. The anode material layer is disposed on at least one surface of the anode current collector. The anode material layer includes an anode active material. The anode material layer further optionally includes a conductive agent and an anode binder. The conductive agent and the anode binder can be uniformly mixed with the anode active material. The anode active material can be selected from the group consisting of graphite, acetylene black, carbon microbeads, carbon fibers, carbon nanotubes and pyrolysis carbon thereof.

### EXAMPLE 1

0.01 g of lithium oleate is dissolved in 50 ml of anhydrous methanol to obtain lithium oleate solution. The lithium oleate solution is added to 50 ml, 0.5 mol/L of barium chloride solution, and homogeneously mixed for 20 minutes to 30 minutes to form the first solution. 50 ml, 0.5 mol/L of the sodium sulfate aqueous solution having a pH of 8-9 adjusted by ammonia water is slowly added to the first solution to form the precipitate. After centrifugation, the precipitate is isolated. The precipitate is washed 3 times with deionized water. The washed precipitate is dried in a vacuum oven at a temperature of 80° C. to obtain the nano-barium sulfate modified with the lithium carboxylate group. Particles of the nano-barium sulfate modified with the lithium carboxylate group have a particle size in a range from about 30 nm to about 50 nm. A specific surface area of the nano-barium sulfate modified with lithium carboxylate group is 19.9 m²/g.

1 g of the nano-barium sulfate modified with the lithium carboxylate group is added to 20 ml of N-methylpyrrolidone solvent, and vigorously stirred for about 3 hours to obtain the mixed solution. 0.05 g of soluble polyimide is added to the mixed solution and stirred for 4 hours, to form the mixed slurry. The mixed slurry is uniformly coated on two sides of a Celgard-2325 film with a thickness of 25 μm, and dried in vacuum oven at a temperature at 60° C. for about 24 hours to obtain the composite barium sulfate diaphragm.

### EXAMPLE 2

0.02 g of lithium stearate is dissolved in 100 ml of N, N-dimethylformamide to obtain lithium stearate solution. The lithium stearate solution is added to 100 ml, 0.5 mol/L of barium chloride solution, and homogeneously mixed for 20 minutes to 30 minutes to form the first solution. 100 ml, 0.5 mol/L of sodium sulfate aqueous solution having a pH of 8-9 adjusted by ammonia water is slowly added to the first solution to form the precipitate. After centrifugation, the precipitate is isolated. The precipitate is washed 3 to 4 times with deionized water. The washed precipitate is dried in a vacuum oven at a temperature of 80° C. to obtain the nano-barium sulfate modified with the lithium carboxylate group. The nano-barium sulfate modified with the lithium carboxylate group has a particle size in a range from about 50 nm to about 80 nm.

1 g of the nano-barium sulfate modified with the lithium carboxylate group is added to 10 ml of N-methylpyrrolidone solvent, and vigorously stirred for 3 hours to obtain the mixed solution. 0.116 g of polyvinylidene fluoride is added to the mixed solution and stirred for 6 hours, to form the mixed slurry. The mixed slurry is uniformly coated on two sides of a Celgard-2325 film with a thickness of 25 μm, and dried in a vacuum oven at a temperature of 60° C. for about 24 hours to obtain the composite barium sulfate diaphragm.

### EXAMPLE 3

0.03 g of lithium polyacrylate is dissolved in 150 ml of acetone to obtain lithium polyacrylate solution. The lithium stearate solution is added to 150 ml, 0.5 mol/L of barium chloride solution, and homogeneously mixed for 20 minutes to 30 minutes to form the first solution. 150 ml, 0.5 mol/L of sodium sulfate aqueous solution having a pH of 8-9 adjusted by ammonia water is slowly added to the first solution to form the precipitate. After centrifugation, the precipitate is isolated. The precipitate is washed 3 times with deionized water. The washed precipitate is dried in a vacuum oven at a temperature of 80° C. to obtain the nano-barium sulfate modified with the lithium carboxylate group. The nano-barium sulfate modified with the lithium carboxylate group has a particle size in a range from about 80 nm to about 120 nm.

1 g of the nano-barium sulfate modified with lithium carboxylate group is added to 10 ml of N-methylpyrrolidone solvent, and vigorously stirred for 2 hours to obtain the mixed solution. 0.15 g of polyacrylonitrile is added to the mixed solution and stirred for 5 hours, to form the mixed slurry. The mixed slurry is uniformly coated on two sides of a Celgard-2325 film with a thickness of 25 μm, and dried in a vacuum oven at a temperature of 60° C. for about 24 hours to obtain the composite barium sulfate diaphragm.

### COMPARATIVE EXAMPLE 1

The difference between the comparative example 1 and example 1 is that the barium sulfate in the diaphragm of comparative example 1 is commercialized nano-barium sulfate instead of the nano-barium sulfate modified with lithium carboxylate group in example 1.

### COMPARATIVE EXAMPLE 2

The difference between comparative example 2 and example 1 is that the diaphragm of comparative example 2 is only a Celgard-2325 film without a coating of nano-barium sulfate.

The same electrolytes of same volume are dropped on the diaphragms of Example 1, Comparative Example 1 and Comparative Example 2 in a same area. After five minutes, the electrolyte spread a large area in the composite barium sulfate diaphragm of Example 1. The electrolyte spreading area in the diaphragm of Comparative Example 1 is less than the electrolyte spreading area of Example 1. The electrolyte spreading area in the diaphragm of Comparative Example 2 is much less than the electrolyte spreading area of Example 1. Absorbing ratios to electrolyte of the diaphragms in Example 1, Comparative Example 1 and Comparative Example 2 can be calculated by formula of

$$A = \frac{m - {m}_{0}}{S} \times 100 \% .$$

In the formula, A is the absorbing ratio, m is the total mass of the diaphragm absorbed with the electrolyte, m₀ is a mass of the diaphragm not absorbed with the electrolyte, and S is a total area of the diaphragm. The test results of the absorbing ratio are shown in Table 1.

TABLE 1

| | Absorbing ratio |
|---|---|
| Example 1 | 3.56 mg/cm² |
| Comparative | 2.46 mg/cm² |
| Example 1 | |
| Comparative | 0.91 mg/cm² |
| Example 2 | |

Diaphragms of Example 1, Comparative Example 1 and Comparative Example 2 having the same area are separately put into a vacuum oven, and separately baked at 120° C., 130° C., 140° C., and 150° C. each for about 0.5 hour. After cooling down to room temperature, thermal shrinkage of the diaphragms can be calculated by the formula of

$$η = \frac{{L}_{0} - L}{{L}_{0}} \times 100 \% .$$

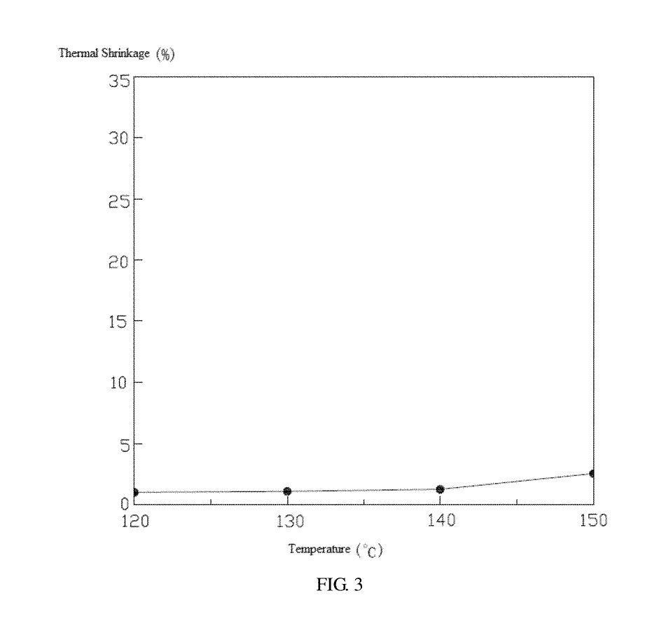

In the formula, η is the thermal shrinkage, L₀ is the original length of the diaphragm, and L is a length of the diaphragm after baking. Referring to FIG. 3, the thermal shrinkage of the diaphragm in Example 1 is maintained in a range of 1% to 3%. The thermal shrinkages of the diaphragms of Example 1, Comparative Example 1 and Comparative Example 2 are respectively tested. The test results of the thermal shrinkages are shown in Table 2.

TABLE 2

| | 120° C. | 130° C. | 140° C. | 150° C. |
|---|---|---|---|---|
| Example 1 | 1.00% | 1.25% | 1.30% | 3.00% |
| Comparative | 2.00% | 3.00% | 4.00% | 6.00% |
| Example 1 | | | | |
| Comparative | 7.10% | 14.80% | 24.36% | 30.10% |
| Example 2 | | | | |

As shown in Table 1, the absorbing ratio of the diaphragm in Example 1 is about 3.56 mg/cm². As shown in Table 2, at temperature of 150° C., and the thermal shrinkage of the diaphragm in Example 1 is about 3%. Compared to the diaphragm made of commercialized nano-barium sulfate in Comparative Example 1, the diaphragm of Example 1 has a higher thermal resistance and better wettability.

The diaphragms of Example 1, Comparative Example 1 and Comparative Example 2 are respectively assembled in lithium-ion batteries. The other components of the lithium-ion batteries are the same. Discharging performance tests of the lithium-ion batteries at discharge rates of 0.1 C, 0.5 C, 1 C, 2 C, 4 C, 8 C are performed. The results of the rate performance test are shown in Table 3.

TABLE 3

| | 0.1 C discharge | 0.5 C discharge | 1 C discharge | 2 C discharge | 4 C discharge | 8 C discharge |
|---|---|---|---|---|---|---|
| | capacity | capacity | capacity | capacity | capacity | capacity |
| | (mAh/g) | (mAh/g) | (mAh/g) | (mAh/g) | (mAh/g) | (mAh/g) |
| Example 1 | 142.5 mAh/g | 138 mAh/g | 135 mAh/g | 129.5 mAh/g | 124 mAh/g | 120 mAh/g |
| Comparative | 141 mAh/g | 138 mAh/g | 134 mAh/g | 128 mAh/g | 115 mAh/g | 112 mAh/g |
| Example 1 | | | | | | |
| Comparative | 144 mAh/g | 138 mAh/g | 134 mAh/g | 129 mAh/g | 125 mAh/g | 121 mAh/g |
| Example 2 | | | | | | |

As shown in Table 3, with increasing discharge rate, the lithium ion battery of Example 1 has roughly an equal discharging performance as the lithium ion battery of Comparative Example 2. The discharging performance of the lithium ion battery of Example 1 is superior to the discharging performance of the lithium ion battery of Comparative Example 1.

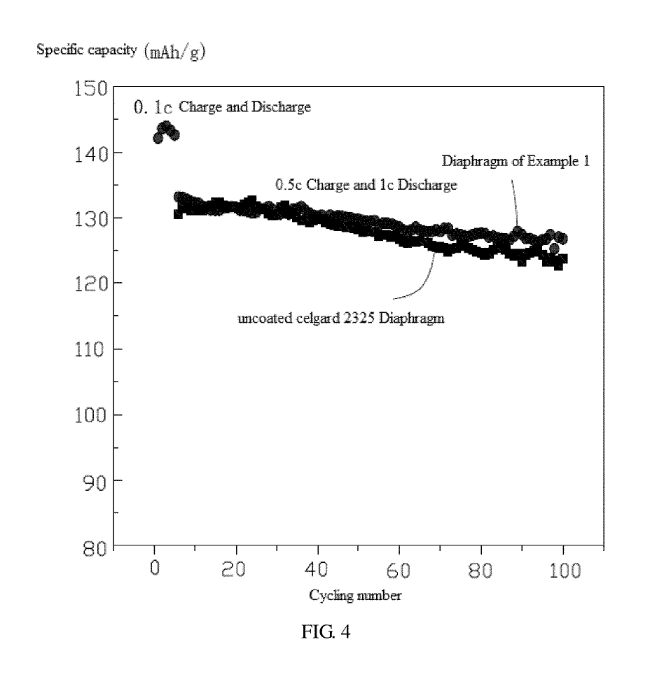

Charge and discharge cycle tests are performed to the lithium-ion batteries with the diaphragms of Example 1, Comparative Example 1 and Comparative Example 2. The lithium-ion batteries performed 5 charge-discharge cycles at 0.1 C, and then charged at 0.5 C and discharged 1 C, till 100 cycles. Referring to FIG. 4 and Table 4, with the increasing number of cycles, cycle performance of the lithium ion battery of Example 1 is better than the lithium ion batteries of Comparative Example 1 and Comparative Example 2.

The method for preparing the composite barium sulfate diaphragm of this disclosure, includes obtaining nano-barium sulfate modified with a lithium carboxylate group. The nano-barium sulfate modified with the lithium carboxylate group is mixed with the binder to obtain the mixed slurry. The mixed slurry is coated on the base membrane to obtain the composite barium sulfate diaphragm. The coating layer is a rigid support to prevent thermal shrinkage of the composite barium sulfate diaphragm. The composite barium sulfate diaphragm provided in this disclosure includes nano-barium sulfate modified with the lithium carboxylic group. The nano-barium sulfate modified with the lithium carboxylic group is easy to disperse uniformly. The nano-barium sulfate modified with the lithium carboxylic group can facilitate the transmission of lithium ions to improve the charge-discharge and cycle performance of the lithium-ion battery applied with the composite barium sulfate diaphragm.

Other embodiments of the disclosure will be apparent to those skilled in the art from consideration of the specification and practice of the embodiments disclosed herein. It is intended that the specification and examples be considered as exemplary only, with the true scope and spirit of the embodiments being indicated by the following claims.

What is claimed is:

1. A composite barium sulfate diaphragm, comprising:
a base membrane; and
a coating layer coated on the base membrane, the coating layer comprising a nano-barium sulfate and binder, and a surface of the nano-barium sulfate being modified with a lithium carboxylate group.

2. The composite barium sulfate diaphragm of claim 1, wherein the lithium carboxylate group comprises at least eight carbon atoms.

3. The composite barium sulfate diaphragm of claim 1, wherein the nano-barium sulfate is a mesoporous material.

4. The composite barium sulfate diaphragm of claim 1, wherein a thickness of the coating layer is in a range from about 2 μm to about 10 μm.

5. A method for preparing a composite barium sulfate diaphragm, comprising:
mixing a lithium carboxylate solution and a soluble barium salt aqueous solution to form a first solution;
providing a soluble sulfate aqueous solution with a pH of 8 to 10, and adding the soluble sulfate aqueous solution to the first solution to cause a reaction to obtain a precipitate;
separating, water washing and drying the precipitate to obtain a nano-barium sulfate modified with a lithium carboxylate group; and
mixing the nano-barium sulfate modified with the lithium carboxylate group and a binder to obtain a mixed slurry, and coating the mixed slurry on a base membrane.

6. The method of claim 5, wherein the lithium carboxylate solution is obtained by dissolving a lithium carboxylate in an organic solvent, and a volume ratio of the organic solvent to the soluble barium salt aqueous solution is in a range from about 1:1 to about 2:1.

7. The method of claim 5, wherein the lithium carboxylate is selected from the group consisting of lithium oleate, lithium stearate, lithium benzoate dodecyl, hexadecyl lithium benzoate, lithium polyacrylate, and combinations thereof.

8. The method of claim 7, wherein a mass of the lithium carboxylate is 1% to 5% by mass of a theoretical mass of the nano-barium sulfate modified with the lithium carboxylate group.

9. The method of claim 5, wherein the mixing the nano-barium sulfate modified with the lithium carboxylate group and the binder to obtain the mixed slurry, and coating the mixed slurry on the base membrane comprises:
mixing and agitating the nano-barium sulfate modified with the lithium carboxylate group and a polar solvent to uniformly disperse the nano-barium sulfate in the polar solvent to obtain a mixed solution;
adding the binder to the mixed solution, and agitating the mixed solution to resolve the binder in the mixed solution to form the mixed slurry; and
coating the mixed slurry on a surface of the base membrane to form a coating layer, and drying the base membrane to obtain the composite barium sulfate diaphragm.

10. The method of claim 9, wherein a mass ratio of the binder to the nano-barium sulfate modified with the lithium carboxylate group is in a range from about 5:100 to about 15:100 in the mixed slurry.

11. A lithium-ion battery, comprising:
a cathode;
an anode;
a composite barium sulfate diaphragm disposed between the cathode and the anode; and
a non-aqueous electrolyte permeated in the composite barium sulfate diaphragm, the composite barium sulfate diaphragm comprising:
a base membrane; and
a coating layer coated on the base membrane, the coating layer comprising a nano-barium sulfate and a binder, and a surface of the nano-barium sulfate being modified with the lithium carboxylate group.

12. The lithium-ion battery of claim 11, wherein the lithium carboxylate group comprises at least eight carbon atoms.

13. The lithium-ion battery of claim 11, wherein the nano-barium sulfate is a mesoporous material.

14. The lithium-ion battery of claim 11, wherein a thickness of the coating layer is in a range from about 2 μm to about 10 μm.
